(19) United States
(12) Patent Application Publication
(10) Pub. No.: US 2006/0159841 A1
(43) Pub. Date: Jul. 20, 2006

(54) Liquid composition, electro-optic device and method for manufacturing the same, organic electroluminescent device and method for manufacturing the same

(75) Inventors: Ayae Endo, Suwa-machi (JP); Masahiro Uchida, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/377,341

(22) Filed: Mar. 17, 2006

Related U.S. Application Data
(63) Continuation of application No. 10/717,596, filed on Nov. 21, 2003.

(30) Foreign Application Priority Data
Nov. 26, 2002 (JP) 2002-342107
Aug. 12, 2003 (JP) 2003-292321

(51) Int. Cl. B05D 5/12

(52) U.S. Cl. 427/66

(57) ABSTRACT

To provide a liquid composition in which changes in physical properties with time are reduced or prevented, and a film-forming apparatus capable of forming a film pattern of the liquid composition with a high productivity a film-forming apparatus includes a liquid composition preparing unit to prepare a liquid composition containing an organic functional material, a solvent, and a metal deactivator; and a liquid discharge apparatus to discharge a liquid containing the liquid composition prepared in the liquid composition preparing unit onto a substrate. Since the liquid composition contains the metal deactivator, changes or degradation in the physical properties with time of the organic functional material can be reduced or prevented.

This is a Continuation of application Ser. No. 10/717,596 filed Nov. 21, 2003, the entire disclosure of which is hereby incorporated by reference in its entirety.

### BACKGROUND OF THE INVENTION

1. Field of Invention

The present invention relates to a liquid composition, a method to form a film and a film-forming apparatus, an electro-optic device and a method to manufacture the same, an organic electroluminescent device and a method to manufacture the same, a device and a method to manufacture the same, and an electronic apparatus.

2. Description of Related Art

To form a fine pattern, such as a wiring pattern of a semiconductor device, photolithography has been used in many cases. A droplet discharge method (liquid discharging) has recently been of interest for forming a pattern and has been disclosed in, for example, Japanese Unexamined Patent Application Publication No. 2000-106278. In the liquid discharge method, a material for forming a pattern is dissolved in a solvent to prepare a liquid (an ink), and the droplets of the liquid (ink droplets) are discharged from a liquid discharge apparatus onto a base material to form a pattern. The liquid discharge method has significant advantages of, for example, allowing large-item small-volume production.

In related art techniques, the physical properties of a composition (ink) containing a liquid may change during discharge or storage of the composition. For example, a liquid composition (ink) essentially containing an organic functional material may change their properties, such as molecular weight and molecular weight distribution, to precipitate the solute or change the physical properties of the solute. Thus, the stability of the composition (ink) or the capability of the composition being discharged is negatively affected. Also, after depositing the composition in a predetermined position, the organic functional material constituting a device may be degraded due to its operation and/or storage. Consequently, the reliability of devices formed of the composition may be negatively affected.

The occurrence of these property changes is not confined to compositions (ink) containing an organic functional material. In particular, the property changes noticeably occur in a composition (ink) containing a metal and a pattern in which a metal component is present around the composition. The metal component can disperse in the organic functional material or the like or transform, thereby negatively affecting the characteristics of the resulting device containing the composition.

### SUMMARY OF THE INVENTION

In view of the foregoing disadvantages, the present invention is provided in order to reduce or prevent changes in the physical properties of the liquid composition with time. The present invention provides a liquid composition in which the physical properties of the solute are not easily changed even if the concentration of the solute is saturated during deposition of the composition.

The present invention also provides a method and a device to form a film pattern of the composition with a high productivity.

The present invention provides a highly reliable electro-optic device and method to manufacture the electro-optic device, organic electroluminescent device and method to manufacture the organic electroluminescent device, and device and method to manufacture the device, using the composition, and to provide an electronic apparatus including these devices.

In order to address the foregoing problems, a liquid composition is provided which contains a solute, a solvent, and a metal deactivator.

By adding the metal deactivator to a liquid containing the solute and the solvent to prepare the liquid composition (ink), the changes in physical properties of the composition and precipitation of the solute due to a metal component can be reduced or prevented to enhance the stability of the liquid composition (ink), even if the liquid contains the metal component or is contaminated with the metal component. The solvent may be appropriately selected from among organic solvents and aqueous solvents according to the physical properties, particularly the solubility, of the solute.

The liquid composition of an aspect of the present invention contains the metal deactivator. Therefore, if the liquid composition contains a metal and/or metal ions, or is contaminated with the metal and/or metal ions, the metal deactivator acts on the metal and/or metal ions to produce an inert metal complex, thereby reducing or preventing the metal catalysis of oxidizing and degrading the solute.

Exemplary metal deactivators include: triazole compounds, such as 2,(2′-hydroxy-3,5′-di-t-butylphenyl)benzotriazoole, 2,(2′-hydroxy-3,5′-di-t-amylphenyl)benzotriazole, and 3-(N-salicyloyl)amino-1,2,4-triazole; and hydrazide compounds, such as 2,3-bis[[3-(3,5-di-t-butyl-4-hydroxyphenyl)propionyl]]propionohydrazide and di-(N′-alkylsalicyloyl hydrazide)decanedicarboxylate.

The solute in the liquid composition may be an organic functional material. Since the organic functional material is liable to change its physical properties due to a metal component, the effect of the foregoing metal deactivator can be more remarkably achieved.

The organic functional material may contain a luminescent material. Consequently, when a luminescent element is produced from the liquid composition containing the luminescent material, changes in the physical properties of the liquid composition and precipitation can be reduced or prevented. Thus, the resulting luminescent element exhibits excellent capability of emitting light.

In the liquid composition of an aspect of the present invention, the organic functional material may be a macromolecule or a constituent of an organic electroluminescent element.

If the organic functional material is a constituent of an organic electroluminescent element, the metal deactivator may be added to a hole injection material (a hole injection layer material) or an organic electroluminescent material, namely, a luminescent material (a luminescent layer material).

Preferably, in the liquid composition of an aspect of the present invention, the metal deactivator is transparent or semitransparent, and more preferably colorless. Since the luminescent device produced from the liquid composition is not colored by the metal deactivator, negative effects of the metal deactivator to the luminous colors of the luminescent device, for example, changes in the luminous colors and degradation of the luminance, can be reduced or prevented. Consequently, a desired luminescent state can be achieved. A sufficiently low content of the metal deactivator in the organic functional material does not affect the luminous color much, even if the metal deactivator is colored.

Preferably, the metal deactivator has a high solubility or dispersibility in the solute, and has a high solubility or dispersibility in the solvent. Specifically, the solubility parameter of the metal deactivator is preferably in the range of 7.0 to 13.0. Thus, the metal deactivator is sufficiently soluble in the solvent and compatible with the solute. Accordingly, the metal deactivator is dispersed sufficiently and, consequently, phase separation does not occur in the resulting film. If the organic functional material is intended for use as a luminescent material, unevenness of luminescence is reduced or prevented by sufficiently dispersing the metal deactivator.

If the organic functional material is intended for use as a hole injection material (hole injection layer material) of an organic electroluminescent element, the solubility parameter of the metal deactivator is preferably in the range of 7.0 to 13.0, and more preferably in the range of 8.5 to 13.0. If the organic functional material is intended for use as a luminescent material (luminescent layer material) of an organic electroluminescent element, the solubility parameter of the metal deactivator is preferably in the range of 7.0 to 13.0, and more preferably in the range of 7.5 to 10.5.

In the liquid composition of an aspect of the present invention, preferably, the solubility of the metal deactivator in the solvent is 0.001% or more. Thus, the metal deactivator is sufficiently soluble in the solvent and, consequently, compatible with the solute, such as the organic functional material. Accordingly, it is dispersed sufficiently in the solute, and, consequently, phase separation does not occur in the resulting film. If the organic functional material serves as a luminescent material, unevenness of luminescence is reduced or prevented by sufficiently dispersing the metal deactivator.

If the organic functional material is intended for use as a hole injection material of an organic electroluminescent element, the solubility of the metal deactivator in the solvent is preferably 0.001% or more, and more preferably 5% or more. If the organic functional material is intended for use as a luminescent material of an organic electroluminescent element, the solubility of the metal deactivator in the solvent is preferably 0.001% or more, and more preferably 5% or more, as above.

Preferably, the metal deactivator content in the liquid composition of an aspect of the present invention is in the range of 0.001 to 30 percent by weight, and more preferably in the range of 0.1 to 10 percent by weight, relative to the organic functional material. Thus, a desired capability can be provided, preventing or reducing changes in the physical properties of the composition.

The liquid composition may further contain an antioxidant, such as a radical chain inhibitor or a peroxide decomposer. Thus, the effect of reducing or preventing changes in physical properties is enhanced. For example, a luminescent element or the like produced from the liquid composition can exhibit enhanced properties. Exemplary radical chain inhibitors include phenol, monophenol, bisphenol, and macromolecular phenol metal deactivators. Exemplary peroxide decomposers include a metal deactivator containing sulfur or phosphorus. The liquid composition may be used in combination with other additives, such as a surfactant, a pH adjuster, and a UV absorber.

An aspect of the present invention is also directed to a method to form a film including the step of mixing a solute, a solvent, and a metal deactivator to prepare a liquid composition, and the step of depositing the liquid composition on a predetermined surface.

Since, in an aspect of the present invention, the liquid composition contains the metal deactivator, changes in the physical properties of the liquid composition and precipitation can be reduced or prevented. Consequently, a uniform film can be efficiently formed and phase separation does not easily occur in the resulting film.

In the film forming method of an aspect of the present invention, an organic functional material may be used as the solute. Since organic functional materials are significantly affected by a metal component to change their properties, the metal deactivator produces a further remarkable effect. For example, a luminescent material is used as the organic functional material to yield a film with excellent luminous characteristics.

The organic functional material may be used for a component of an organic electroluminescent element, a color filter, an organic thin-film transistor element, or a liquid crystal element. By adding the metal deactivator to the materials of these components, the resulting elements deliver good performance.

The metal deactivator may have a high dispersibility and solubility in the solute and the solvent. The liquid composition containing such a metal deactivator is discharged from a liquid discharge apparatus onto a predetermined surface to form a film. In other words, the liquid composition of an aspect of the present invention can be deposited on a predetermined surface by liquid discharging (a droplet discharge method). Since the composition contains the metal deactivator, changes in its physical properties and precipitation can be reduced or prevented. Accordingly, the discharge operation of a liquid discharge apparatus becomes stable with less clogging, and the liquid discharge apparatus can provide desired film patterns in which phase separation does not easily occur. The method to form a film of the composition of the aspect of the present invention is not limited to by liquid discharging, but it may be achieved by spin coating and other coating techniques (deposition techniques).

In another form of the film forming method of an aspect of the present invention may include: the step of depositing a first composition containing a solute and a solvent onto a predetermined surface to form a first film; and the step of forming a second film containing a metal deactivator on the first film.

Specifically, the solute, such as an organic functional material, is dissolved in the solvent to prepare a liquid (ink), and a film is formed of the first composition. Then, the metal deactivator is deposited on the film.

Preferably, a second composition containing the metal deactivator and a solvent is prepared before the deposition of the metal deactivator. The second composition is delivered to a liquid discharge apparatus through a path and discharged from the liquid discharge apparatus onto the first film. Thus, the metal deactivator is provided on the first film. By depositing the second film containing the metal deactivator with the liquid discharge apparatus, a desired film pattern containing the metal deactivator can easily be formed. Preferably, the pass is cut off from outside air.

After depositing the first composition on a base material, the first composition (first film) may be subjected heat treatment (baking) to remove the solvent, and then, the second composition is discharged. The second composition may be discharged right after deposition of the first composition, with the first film being wet on the base material. By discharging the second composition onto the wet first composition on the base material, the first composition and the second composition, which contains the metal deactivator, can be mixed on the base material. The second composition may be a solution containing the metal deactivator and a solvent, or a liquid containing the metal deactivator, a solvent, and a synthetic resin serving as a binder. If the second composition contains the metal deactivator, a solvent, and a synthetic resin, an organic functional material layer and a synthetic resin layer containing the metal deactivator are layered. The synthetic resin is not limited to a binder, but any material not affecting the organic functional material may be used.

An aspect of the present invention is also directed to a film-forming apparatus including a liquid composition-preparing unit to prepare a liquid composition containing a solute, a solvent, and a metal deactivator and a liquid discharge apparatus to discharge a liquid containing the liquid composition onto a predetermined surface.

Since the film-forming apparatus includes a unit to prepare the liquid composition containing the metal deactivator and an apparatus to discharge a liquid containing the liquid composition, it makes it possible to form a film, maintaining a high discharge stability while reducing or preventing changes in the physical properties of the liquid composition and precipitation of the composition. Consequently, a uniform film can be efficiently formed. Furthermore, phase separation does not occur in the resulting film and the function of the resulting thin film is not negatively affected. By depositing a film with the liquid discharge apparatus, a desired film pattern can be easily formed.

If, for example, the composition prepared by the liquid composition-preparing unit is not allowed to come into contact with outside air during transmitting of the composition to the liquid discharge apparatus, the stability of the composition can further be enhanced.

An aspect of the present invention is also directed to another film-forming apparatus including a liquid composition-preparing unit to prepare a liquid composition containing a material of an organic electroluminescent element, a solvent, and a metal deactivator and a liquid discharge apparatus to discharge a liquid containing the liquid composition onto a predetermined surface.

Since the metal deactivator is added to the composition containing a material of an organic electroluminescent element, changes in the physical properties of the composition and precipitation of the composition can be reduced or prevented.

Consequently, a uniform film can efficiently be produced and an organic electroluminescent element with a desired capability can be manufactured without phase separation in the resulting film.

The film-forming apparatus may include a stage capable of movably supporting a base material having the predetermined surface. This structure allows the liquid composition to be discharged onto the predetermined surface with the base material moving, and, thus, a film can be efficiently formed.

An aspect of the present invention is also directed to an electro-optic device including a functional element containing a metal deactivator.

Since the functional element contains the metal deactivator, changes in the physical properties of the material of the functional element and precipitation of the material can be reduced or prevented during manufacture of the element. Also, changes or degradation in the physical properties of the resulting device with time can be reduced or prevented as to the functional element, and, accordingly, the electro-optic device can exhibit a high reliability.

An aspect of the present invention is also directed to another electro-optic device including a functional element and a metal deactivating layer containing a metal deactivator on the functional element.

Specifically, the metal deactivator may be provided in a metal deactivating layer or film other than the functional element, apart from the structure in which the metal deactivator is contained in the functional element. In this case, changes or degradation with time in the properties of the device can be reduced or prevented as to the functional element as in above. In particular, by providing the metal deactivating layer between a metal layer and a functional element layer, the changes or degradation with time in the properties of the element can be further reduced or prevented. Consequently, the resulting electro-optic device can provide a still higher reliability.

In the electro-optic device of an aspect of the present invention, the functional element may be a luminescent element. In other words, the functional element may be formed of a luminescent material. Thus, the electro-optic device is given an excellent capability of emitting light. Alternatively, the functional element may be an organic electroluminescent element.

An aspect of the present invention is also directed to a method to manufacture an electro-optic device including a functional element. The method includes the step of adding a metal deactivator to a solution containing a material of the functional element and a solvent to prepare a liquid composition, and the step of depositing the liquid composition on a base material to form a film serving as a component of the functional element.

Since the liquid composition is essentially composed of the functional element material, the solvent, and the metal deactivator, changes in the physical properties of the material and precipitation do not occur during the preparation and storage of the liquid composition. Since the film is formed of the liquid composition, phase separation is reduced or prevented in the resulting film and changes in the physical properties of the functional element do not easily occur in the film.

In the method to manufacture an electro-optic device, the film may be formed by discharging a liquid containing the liquid composition from a liquid discharge apparatus onto a base material. Thus, a desired film pattern is easily obtained.

As aspect of the present invention is also directed to another method to manufacture an electro-optic device including a functional element. The method includes the step of depositing a first composition containing a material of the functional element and a solvent on a base material to form a first film being a component of the functional element, and the step of forming a second film containing a metal deactivator on the first film.

Specifically, after the first film being a component of the functional element has been formed on the base material, the second film containing the metal deactivator is provided on the first film. Thus, changes in physical properties of the functional element do not easily occur in the film, as in above.

In the step of forming the second film containing the metal deactivator, a second composition containing the metal deactivator and the solvent may be prepared, and then, a liquid containing the second composition may be discharged from a liquid discharge apparatus onto the first film. The second composition may contain a synthetic resin as a binder, and this second composition containing the synthetic resin is discharged. The functional element may be an organic electroluminescent element.

An aspect of the present invention is also directed to an organic electroluminescent device including a plurality of material layers. At least one of the material layers contains a metal deactivator.

By adding the metal deactivator to the material layer, property changes or degradation of the material layer of the organic electroluminescent device with time or operation can be reduced or prevented, and the resulting organic electroluminescent device can exhibit a high reliability.

Preferably, the metal deactivator is contained in a luminescent layer, which is one of the material layers of the organic electroluminescent device. Thus, changes or degradation with time in the physical properties of the luminescent layer can be reduced or prevented, and, consequently, the resulting organic electroluminescent device exhibits excellent luminous characteristics. Also, a hole injection layer among the material layers may contain the metal deactivator. In this case, changes or degradation with time in the physical properties of the hole injection layer can be reduced or prevented, as in above.

An aspect of the present invention is also directed to another organic electroluminescent device including: a plurality of material layers; and an antioxidant layer containing a metal deactivator between predetermined two layers of the material layers.

In other words, in the organic electroluminescent device, the metal deactivator may be contained in an additional layer (metal deactivating layer) between two of the material layers, apart from the structure in which the metal deactivator is contained in at least one of the material layers. If a metal layer containing a metal component is provided over the material layers and the metal deactivating layer, this structure does not easily allow the metal layer to change or degrade the physical properties of the organic electroluminescent device. Thus, the resulting organic electroluminescent device can exhibit a high reliability.

An aspect of the present invention is also directed to a method to manufacture an organic electroluminescent device including a plurality of material layers. The method includes the step of adding a metal deactivator to a solution containing a material of at least one of the material layers and a solvent to prepare a liquid composition, and the step of forming the material layer of the liquid composition.

Since the metal deactivator is added to the liquid composition containing a material of the material layers, changes in the physical properties of the composition and precipitation of the solute can be reduced or prevented during the deposition and storage of the liquid composition. By forming the material layer of the composition, problems, such as phase separation, can be reduced or prevented. Thus, a highly reliable organic electroluminescent device can be manufactured.

In the method to manufacture an organic electroluminescent device of an aspect of the present invention, the material layer may be formed by discharging a liquid containing the liquid composition from a liquid discharge apparatus. In this case, liquid discharging (a droplet discharge method) makes it possible to form the material layers easily with a good workability.

An aspect of the present invention is also directed to another method to manufacture an organic electroluminescent device including a plurality of material layers. The method includes the step of forming a first material layer using a first composition containing a material of at least one of the material layers and a solvent, and the step of forming a second material layer containing a metal deactivator on the first material layer.

For example, the first material layer includes material layers, such as a luminescent layer and a hole injection layer, and the second material layer containing the metal deactivator is provided in contact with the first material layer. If the organic electroluminescent device includes a metal layer containing a metal component, the metal layer is formed on the first material layer with the second material layer therebetween. Consequently, the luminescent layer and the hole injection layer in the first material layer is not easily affected to change or degrade the physical properties by the adjacent metal layer.

For depositing the metal deactivator, a second composition may be prepared from the metal deactivator and a solvent, and a liquid containing the second composition is discharged onto the first material layer from the liquid discharge apparatus. In this case, liquid discharging (a droplet discharge method) makes it possible to form the second material layer easily with a good workability.

An aspect of the present invention is also directed to a device formed using the liquid composition described above. Also, a method to manufacture a device is provided in which the liquid composition is used. The method to manufacture a device includes the step of discharging a liquid essentially composed of the liquid composition from a liquid discharge apparatus. Thus, a highly reliable device can be provided.

An aspect of the present invention is also directed to an electronic apparatus including the electro-optic device described above. An aspect of the present invention is also directed to another electronic apparatus including the organic electroluminescent device described above. Thus, an electronic apparatus having excellent characteristics can be provided.

A liquid discharge apparatus (droplet discharge apparatus) of an aspect of the present invention may be an ink jet apparatus having an ink jet head (liquid discharge head). The ink jet head of the ink jet apparatus can quantitatively discharge a liquid composition by ink jetting. For example, it intermittently discharges 1 to 300 ng of the liquid composition quantitatively for each dot. The liquid discharge apparatus may be a dispenser.

The discharge of the liquid discharge apparatus may be based on piezoelectric jetting in which the liquid composition is discharged by changing the volume of a piezoelectric element, or based on a technique in which the liquid composition is discharged by heating to rapidly generate steam.

The liquid composition refers to a viscous medium capable of being discharged (dripped) from nozzles of a discharge head of a liquid discharge apparatus. It may be water-based or oil-based. It may contain a solid material as long as it has such flowability (viscosity) as to be discharged from nozzles or the like. The constituents of the liquid composition may be melted by heating to their melting point or more, or may be particles dispersed in a solvent. The liquid composition may contain a dye or a pigment and other functional materials in addition to the solvent. The base material may be a flat or curved substrate. The surface on which a pattern is formed is not necessarily hard. The surface may be not only of glass, plastics, or metal, but also of a film, paper, rubber, or other flexible materials.

### BRIEF DESCRIPTION OF THE DRAWINGS

FIG. 1 is a schematic representation of a film-forming apparatus according to an exemplary embodiment of the present invention.

FIG. 2 is a representation of a liquid discharge head.

FIG. 3 is a representation of a liquid discharge head.

FIG. 4 is a plan view of an electro-optic device according to an exemplary embodiment of the present invention.

FIG. 5 is a sectional view of a substrate used in a process of manufacturing an organic EL panel shown in FIG. 4.

FIG. 6 is a sectional view of a step of a method to manufacture an organic EL element.

FIG. 7 is a sectional view of a step of a method to manufacture an organic EL element.

FIG. 8 is a sectional view of a step of a method to manufacture an organic EL element.

FIG. 9 is a sectional view of a step of a method to manufacture an organic EL element.

FIG. 10 is a sectional view of a step of a method to manufacture an organic EL element.

FIG. 11 is a sectional view of another method to manufacture an organic EL element.

FIG. 12 is a plot of properties of an organic EL device of an exemplary embodiment of the present invention and a related art organic EL device, obtained from a test.

FIG. 13 is a plot of properties of an organic EL device of an exemplary embodiment of the present invention and a related art organic EL device, obtained from a test.

FIG. 14 is a plot of properties of an organic EL device of an exemplary embodiment of the present invention and a related art organic EL device, obtained from a test.

FIG. 15 is a plot of properties of an organic EL device of an exemplary embodiment of the present invention and a related art organic EL device, obtained from a test.

FIG. 16 is a representation of the structure of a color filter.

FIG. 17(a) is a sectional view of a step of a process to form a color filter. FIG. 17(b) is a sectional view of a step of a process to form a color filter. FIG. 17(c) is a sectional view of a step of a process to form a color filter. FIG. 17(d) is a sectional view of a step of a process to form a color filter. FIG. 17(e) is a sectional view of a step of a process to form a color filter. FIG. 17(f) is a sectional view of a step of a process to form a color filter.

FIG. 18 is a representation of the structure of a liquid crystal device.

FIG. 19 is a representation of the structure of an organic TFT element.

FIG. 20 is a representation of an electronic apparatus including an electro-optic device of an exemplary embodiment of the present invention.

### DETAILED DESCRIPTION OF PREFERRED EMBODIMENTS

Exemplary embodiments of the present invention will now be described with reference to figures.

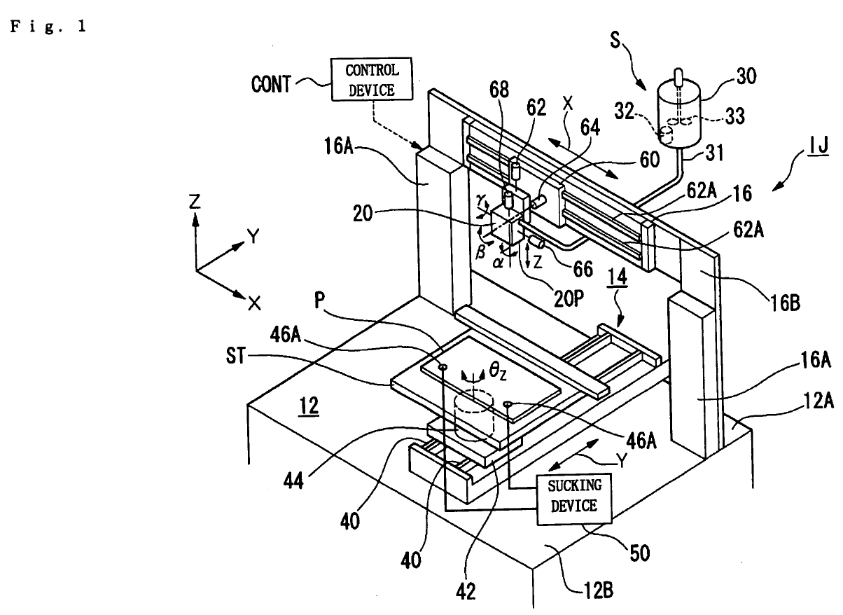

FIG. 1 is a schematic perspective view of a liquid discharge apparatus, which is a type of film-forming apparatus, according to an exemplary embodiment of the present invention.

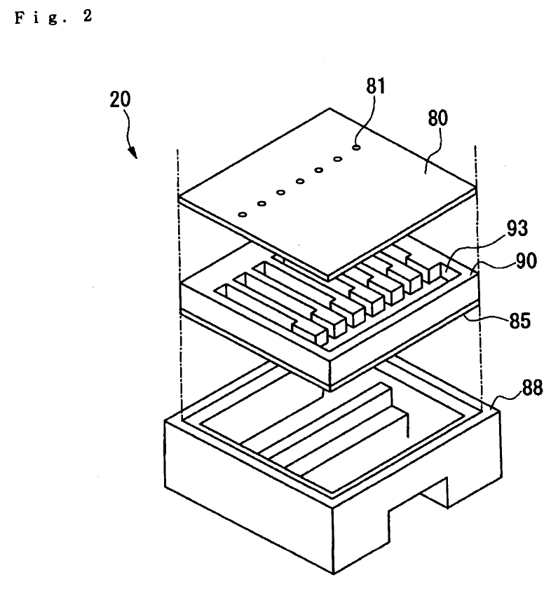

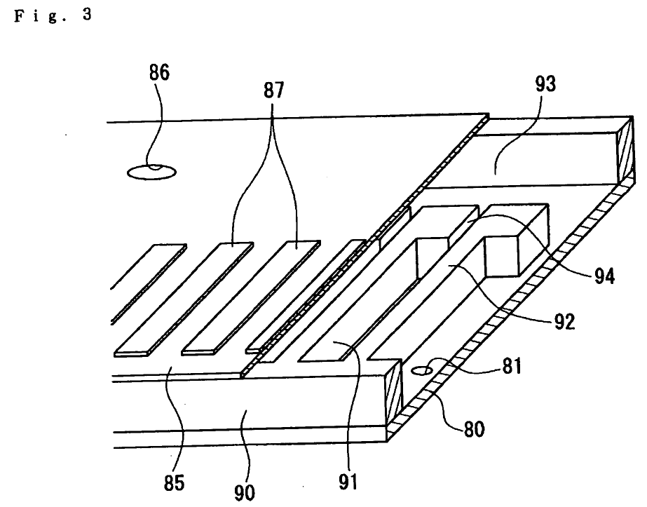

FIGS. 2 and 3 show a liquid discharge head included in the liquid discharge apparatus.

In FIG. 1, the liquid discharge apparatus IJ is used to deposit a liquid composition on a surface (predetermined surface) of a substrate (base material) P. The liquid discharge apparatus IJ includes a base 12, a stage (stage device) ST to hold the substrate P, a first shifter 14 to shift and support the stage ST between the base 12 and the stage ST, a liquid discharge head 20 capable of quantitatively discharging (dripping) the liquid composition containing an organic functional material onto the substrate P held by the stage ST, and a second shifter 16 to shift and support the liquid discharge head 20. The operations of the liquid discharge apparatus IJ, including those of the liquid discharge head 20 discharging the liquid composition and those of the first shifter 14 and second shifter 16 shifting are controlled by a control device CONT.

The first shifter 14 is disposed on the base 12 and is positioned along the Y-axis direction. The second shifter 16 is fixed to support posts 16A standing on the base 12, at the backside 12A of the base 12. The X-axis direction in which the second shifter 16 moves is perpendicular to the Y-axis direction in which the first shifter 14 moves. The Y-axis direction is along the foreside 12B direction and backside 12A direction of the base 12. In contrast, the X-axis direction is along the transverse direction of the base 12. Each of the directions is horizontal. The Z-axis direction is perpendicular to the X and Y-axis directions.

The first shifter 14 is based on, for example, a linear motor, and includes guide rails 40 and a slider 42 disposed in such a manner as to be able to shift along the guide rails 40. The slider 42 of the linear-motor first shifter 14 is shifted in the Y-axis direction along the guide rails 40 to be positioned.

The slider 42 has a motor 44 to rotate in a direction (θz) on the Z-axis. The motor 44 is, for example, of a direct drive, and the rotor of the motor 44 is fixed to the stage ST. Thus, the motor 44 energized allows the rotor and the stage ST to shift together in the θz direction, thereby indexing the stage ST. Hence, the first shifter 14 moves the stage ST in the Y-axis direction and the θz direction.

The stage ST holds the substrate P and moves it to predetermined position, holding the substrate P. The stage ST includes a sucking device 50. The sucking device 50 sucks the substrate P through holes 46A in the stage ST to support it on the stage ST.

The second shifter 16 is based on a linear motor, and includes columns 16B fixed to the respective support posts 16A, a guide rail 62A supported by the columns 16B, and a slider 60 supported in such a manner as to be able to shift in the X-axis direction along the guide rail 62A. The slider 60 shifts in the X-axis direction along the guide rail 62A to be positioned. The liquid discharge head 20 is hung to the slider 60.

The liquid discharge head 20 includes motors 62, 64, 66, and 68 acting as positioning devices in swinging directions. The liquid discharge head 20 is vertically shifted along a Z-axis to be positioned by activating the motor 62. The Z-axis extends in the direction (vertical direction) perpendicular to an X-axis and a Y-axis. The liquid discharge head 20 swings on a Y-axis in the β direction to be positioned by activating the motor 64. The liquid discharge head 20 also swings on an X-axis in the γ direction to be positioned by activating the motor 66. The liquid discharge head 20 also swings on the Z-axis in the α direction to be positioned by activating the motor 68. In other words, the second shifter 16 supports the liquid discharge head 20 in such a manner as to be able to shift it in the X direction and the Z direction and to move it in the θy direction, θy direction, and θz direction.

As described above, the liquid discharge head 20 shown in FIG. 1 is able to shift linearly in the Z-axis direction to be positioned and to swing in the α, β, and γ directions to be positioned, on the slider 60. The position or orientation of the liquid discharge face 20P of the liquid discharge head 20 is able to be precisely controlled with respect to the substrate P on the stage ST. The liquid discharge face 20P of the liquid discharge head 20 is also provided with a plurality of nozzles to discharge the liquid composition.

FIG. 2 is an exploded perspective view of the liquid discharge head 20. The liquid discharge head 20 includes a nozzle plate 80 having nozzles 91, a pressure chamber substrate 90 having a diaphragm 85, and a case 88 into which the nozzle plate 80 and the diaphragm 85 are fit. As shown in FIG. 3, a fragmentally sectional view of the perspective view, the liquid discharge head 20 is essentially structured such that the pressure chamber substrate 90 is sandwiched between the nozzle plate 80 and the diaphragm 85. The nozzle plate 80 is provided with the nozzles 91 in the positions that are to correspond to cavities (pressure chambers) 91 when it is bonded to the pressure chamber plate 90. The pressure chamber substrate 90 is provided with a plurality of cavities 91 so as to serve as pressure chambers by etching, for example, a silicon single crystal substrate. The cavities 91 are partitioned by sidewalls 92. The cavities 91 communicate with a reservoir 93, which is a common channel, through supply holes 94. The diaphragm 85 is formed of, for example, a thermally oxidized film. The diaphragm 85 is provided with a tank hole 86 through which can be supplied a desired liquid composition delivered along a pipe (pass) 31 from a tank 30 serving as a liquid composition preparing unit S, described later. Piezoelectric elements 87 are disposed in the positions corresponding to the cavities 91, on the diaphragm 85. Each piezoelectric element 87 includes a piezoelectric ceramic crystal, such as a PZT element, laid between an upper electrode and a lower electrode (not shown in the drawing). The piezoelectric element 87 changes its volume according to a discharge signal supplied from the control device CONT.

In order to discharge a liquid composition from the liquid discharge head 20, the control device CONT supplies a discharge signal to discharge the liquid composition to the liquid discharge head 20. The liquid composition flows into the cavities 91 of the liquid discharge head 20. In the liquid discharge head 20 that has received the discharge signal, the volumes of the piezoelectric elements 87 are changed according to the voltage applied between their upper electrodes and lower electrodes. The changes in volume transform the diaphragm 85 to change the volume of the cavities 91. As a result, the droplets of the liquid composition are discharged from nozzle holes of the cavities 91. An amount of the liquid composition equivalent to the volume reduced by discharge is supplied to the cavities 91 from the tank 30, described later.

Although the above-described liquid discharge head is structured such that a liquid composition is discharged by changing the volume of the piezoelectric elements, the liquid composition may be heated with a heater to expand and to be discharged as droplets.

Turning back to FIG. 1, the liquid composition deposited on the substrate P is prepared by a liquid composition-preparing unit S. The liquid composition preparing unit S includes the tank 30, a thermoregulator 32 housed in the tank 30 to control the temperature of the liquid composition and a stirrer 33 to stir the liquid composition in the tank 30. The thermoregulator 32 includes a heater, and adjusts the temperature of the liquid composition in the tank 30 to a desired value.

In the liquid composition preparing unit S of the exemplary embodiment, a metal deactivator is added to a solution containing an organic functional material (solute) and a solvent to prepare the liquid composition. The tank 30 is connected with an organic functional material supplier (not shown in the figure) to supply the organic functional material to the tank 30, a solvent supplier (not shown in the figure) to supply the solvent to the tank 30, and a metal deactivator supplier (not shown in the figure) to supply the metal deactivator. The organic functional material, the solvent, and the metal deactivator supplied to the tank 30 from the respective suppliers are stirred by the stirrer 33 to yield the liquid composition containing the organic functional material, the solvent, and the metal deactivator. The materials of the liquid composition are uniformly dispersed by being stirred by the stirrer 33. The thermoregulator 32 is controlled by the control device CONT. The thermoregulator 32 controls the temperature of the liquid composition in the tank 30 to adjust the viscosity to a desired level.

If the liquid composition contains a metal component or is contaminated with a metal component, the metal deactivator takes in the metal composition, thereby inhibiting the activation of the metal component to reduce or prevent the metal component from reacting or interacting with the organic functional material. Triazole compounds and hydrazide compounds, as shown in Table 1, may be used as the metal deactivator. For example, Ciba Specialty IRGANOX MD1024 produced by Ciba-Geigy is preferably used.

TABLE 1
Metal Deactivator

| | Solubility |
|---|---|
| Material | parameter |
| 2,(2′-hydroxy-3,5′-di-t-butylphenyl)benzotriazole | 8.5 to 11.5 |
| 2,(2′-hydroxy-3,5′-di-t-amylphenyl)benzotriazole | 7.3 to 11.5 |
| 2,3-bis[[3-(3,5-di-t-butyl-4- | 8.5 to 11.5 |
| hydroxyphenyl)propionyl]]propionohydrazide | |
| 3-(N-salicyloyl)amino-1,2,4-triazole | 8.5 to 12.9 |
| di-(N′-alkylsalicyloyl hydrazide)decanedicarboxylate | 7.3 to 12.9 |

The tank 30 communicates with the liquid discharge head 20 through the pipe (pass) 31, and the liquid composition discharged from the liquid discharge head 20 is supplied from the tank 30 through the pipe 31. The temperature of the liquid composition flowing through the pipe 31 is set at a predetermined value to adjust the viscosity by a pipe temperature controller, not shown in the figure. Furthermore, the temperature of the liquid composition discharged from the liquid discharge head 20 is controlled to adjust the viscosity to a desired level by a thermoregulator, not shown in the figure, provided in the liquid discharge head 20.

Although FIG. 1 shows only one set of the liquid discharge head 20 and the liquid composition-preparing unit S, the liquid discharge apparatus IJ includes a plurality of sets of the liquid discharge head 20 and the liquid composition-preparing unit S. The plurality of liquid discharge heads 20 discharge the same or different types of liquid composition. A first liquid composition is discharged onto the substrate P from a first liquid discharge head of the liquid discharge heads 20, followed by baking or drying. Then, a second liquid composition is discharged onto the substrate P from a second liquid discharge head, followed by baking or drying. By discharging liquid compositions with the plurality of liquid discharge heads in the same manner, a plurality of material layers are deposited one on top of another to form a multilayer pattern.

Electro-Optic Device and Method to Manufacture the Same

A method to form, on the substrate P, a film pattern of the liquid composition prepared in the liquid composition-preparing unit S will now be described. One example is that a film constituting an organic electroluminescent device (hereinafter referred to as an organic EL device) is manufactured.

In an aspect of the present invention, a metal deactivator is added to a solution containing an organic functional material and a solvent to prepare a liquid composition, and this liquid composition is used to form a film. As an example, the following description shows a process in which a metal deactivator is added to both a hole injection layer and a luminescent layer of the organic EL device. More specifically, the metal deactivator is added to a hole injection layer material (hole injection material) and a luminescent layer material (luminescent material), both of which act as organic functional materials, using the liquid composition preparing unit S. The following procedure and the constituents of liquid compositions are shown as just an example, and do not limit the scope of the invention.

First, the structure of the organic EL device, one type of electro-optic devices, including organic EL elements as functional elements, will be described.

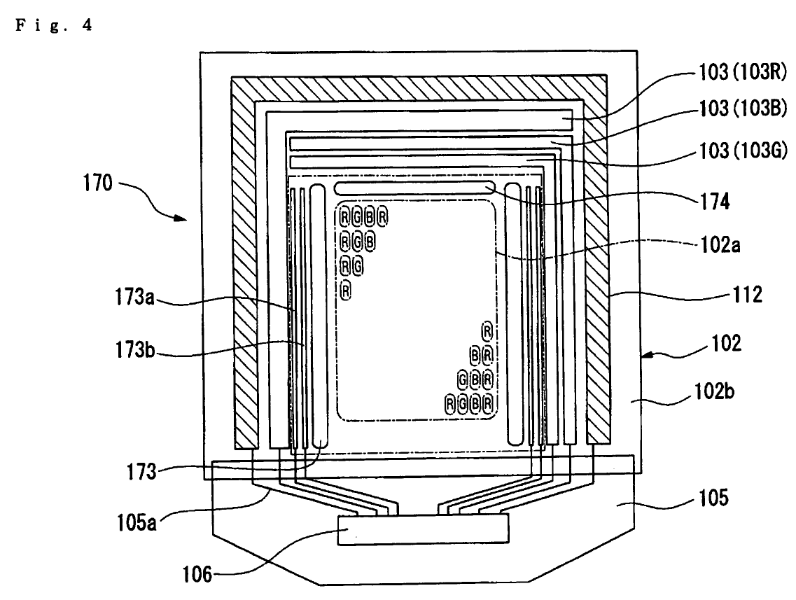

FIG. 4 is a plan view of an organic EL panel, being an electro-optic device, and reference numeral 170 in FIG. 4 designates the organic EL panel. The organic EL panel 170 includes a substrate 102 formed of glass or the like, a large number of organic EL elements that form pixels arranged in a matrix manner, and a sealing plate (not shown in the figure).

The substrate 102 is formed of a transparent material, such as glass, and is partitioned into a display area 102a in the central region of the substrate 102 and a non-display area 102b surrounding the display area 102a in the outer region on the substrate 102. The display area 102a, which may be referred to as an effective display area, includes the organic EL elements arranged in a matrix manner.

A circuit element portion (not shown in the figure) is provided between the substrate and an organic EL element portion (not shown in the figure) including the organic EL elements and barrier walls (not shown in the figure). The circuit element portion includes scanning lines, signal lines, hold capacitors, and thin-film transistors serving as switching elements.

In the non-display area 102b, which is in the outer region on the substrate 102, a cathode line 112 runs to cathodes (opposing electrodes) of the organic EL elements forming the pixels. The ends of the cathode line 112 are connected with wires 105a on a flexible board 105. The wires 105a are connected to a driving IC 106 (driving circuit) on the flexible board 105.

Power lines 103 (103R, 103G, and 103B) are also provided in the circuit element portion in the non-display area 102b.

Scanning driving circuits 173 are disposed at both sides of the display area 102a. The scanning driving circuits 173 are provided in the circuit element portion. The circuit element portion is also provided therein with driving circuit control lines 173a and driving circuit power lines 173b connected to the scanning driving circuit 173.

Furthermore, a test circuit 174 is disposed at one side of the display area 102a. The test circuit 174 tests the quality of the display device and checks for defects of the display device during manufacture or before shipping.

The organic EL element portion is covered with a sealing member (not shown in the figure). The sealing member is essentially composed of a sealing resin applied on the substrate 2 and a sealing substrate.

A method to form the organic EL element being a component of the organic EL panel will be described below.

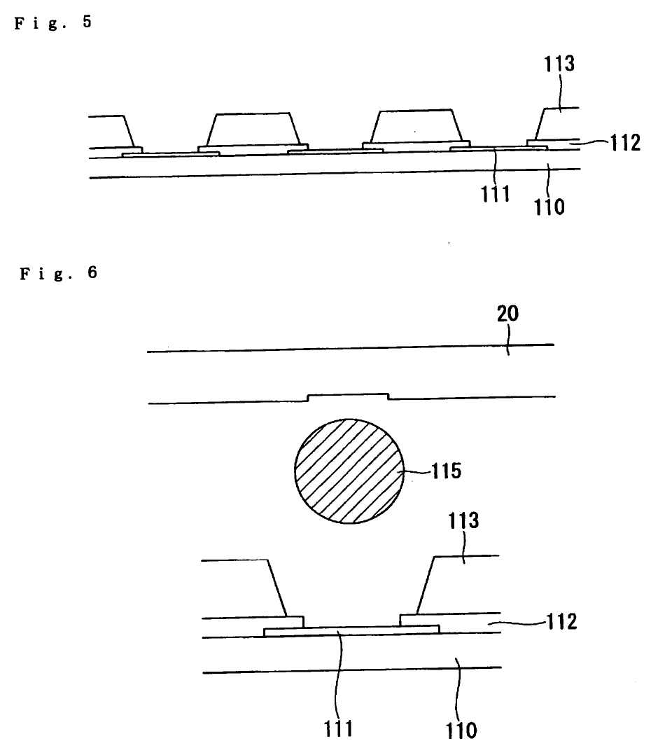

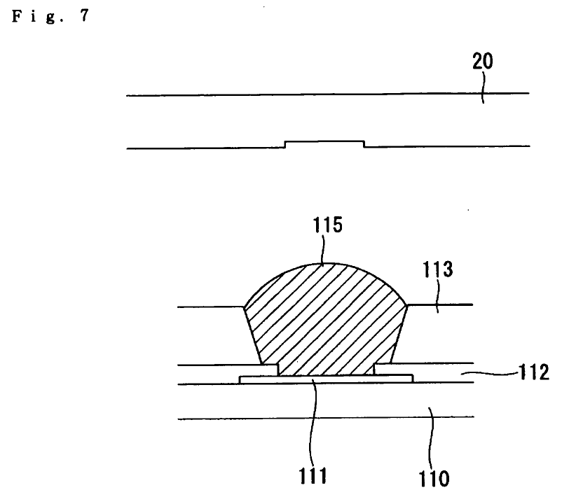

FIGS. 6 to 10 show one among the plurality of pixels that are arranged at a pitch of 70.5 μm, as shown in FIG. 5. Specifically, laminates, each including a SiO₂ layer 112 and a polyimide layer 113 are formed on a glass substrate 110 with ITO films 111 patterned by photolithography, as shown in FIG. 5. The openings between the laminates (between the SiO₂ layers) have a width of 28 μm and a height of 2 μm. The width between the tops of the polyimide layers is 32 μm.

The polyimide layers (polyimide banks) are subjected to ink-repellent treatment with atmospheric plasma before applying a hole injection/transport material composition. The atmospheric plasma treatment is performed under atmospheric pressure, at a power of 300 W and an electrode-substrate interval of 1 mm. Oxygen plasma is applied at an oxygen gas flow rate of 80 SCCM, a helium gas flow rate of 10 SLM, and a table carrying speed of 5 mm/s, and subsequently CF₄ plasma is applied at a CF₄ gas flow rate of 100 SCCM, a helium gas flow rate of 10 SLM, and a table carrying speed of 3 mm/s.

After the surface treatment of the substrate, hole injection/transport material composition (solution) A shown in Table 2 is prepared under an atmosphere of an inert gas in, for example, a glove box (nitrogen gas of 1.1 atm, water concentration of 1 ppm or less, oxygen concentration of 1 ppm or less). Then, hole injection/transport material composition (solution) A shown in Table 2 and a metal deactivator shown in Table 1 are mixed to prepare a liquid composition. The liquid composition 115 in an amount of 15 pL is discharged from the liquid discharge head 20 (see FIG. 1) to form a pattern, as shown in FIGS. 6 to 8. The discharge is performed at a water concentration of 1% or less and an oxygen concentration of 1 ppm or less, in an atmosphere of nitrogen gas. Then, the solvent is removed in a vacuum (1 Torr) at room temperature for 20 minutes, and subsequently heat treatment is performed at 200° C. (on a hot plate) for 10 minutes in a normal atmosphere to yield a hole injection/transport layer 116.

TABLE 2
Hole Injection/Transport Material Composition A

| Composition | Material | Content (wt %) |
|---|---|---|
| Hole injection/transport | Baytron P | 11.08 |
| material | Polystyrene sulfonate | 1.45 |
| Polar solvent | Isopropyl alcohol | 10 |
| | N-methylpyrrolidone | 27.47 |
| | 1,3-dimethyl-imidazolinone | 50 |

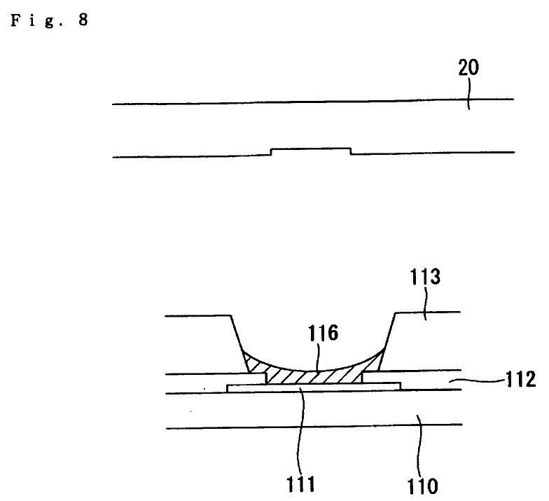

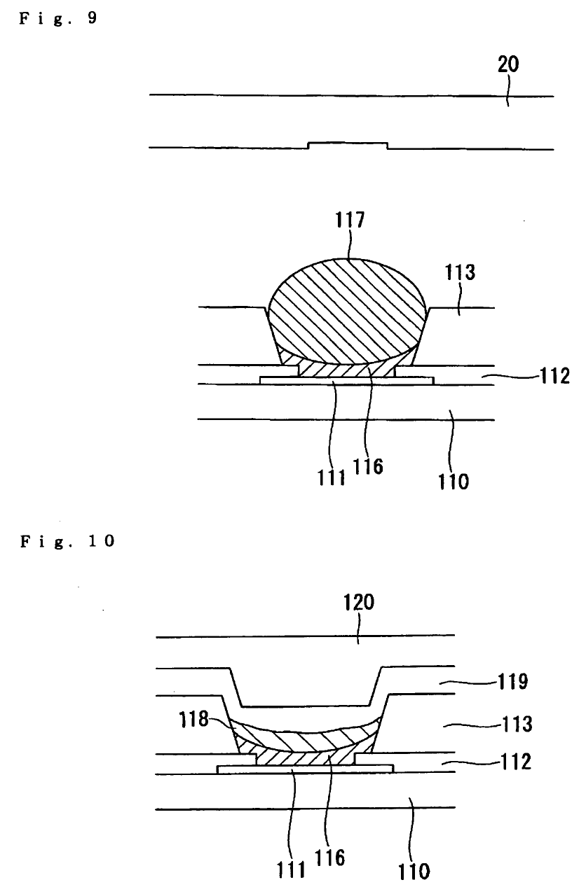

A green luminescent layer composition (liquid composition) 117 containing Composition G shown in Table 3 and a metal deactivator is discharged in an amount of 20 pL from the liquid discharge head 20 (see FIG. 1) to form a pattern on the substrate, as shown in FIGS. 9 to 10. The substrate is heated to 60° C. on a hot plate to remove the solvent, and, thus, a green luminescent layer 118 is formed. As for Compositions B and R shown in Table 3, liquid compositions, each containing a metal deactivator, are discharged from the liquid discharge apparatus to form a blue luminescent layer and a red luminescent layer, as in above. Furthermore, a cathode 119 is formed by vapor deposition, and finally, a sealing layer 120 is formed of an epoxy resin. Thus an organic element is completed.

TABLE 3

| Compo- | Luminescent | | | | Compound |
|---|---|---|---|---|---|
| sition | material (g) | | Solvent (mL) | | A (mg) |
| G | Compound 1 | 0.76 | Cyclohexylbenzene | 40 | 1 |
| (Green) | Compound 2 | 0.20 | 2,3-dihydrobenzofuran | 60 | |
| | Compound 3 | 0.04 | | | |
| B | Compound 1 | 1.00 | Cyclohexylbenzene | 40 | 1 |
| (Blue) | | | 2,3-dihydrobenzofuran | 60 | |
| R | Compound 4 | 1.00 | Cyclohexylbenzene | 40 | 1 |
| (Red) | | | 2,3-dihydrobenzofuran | 60 | |

Compounds 1 to 4 shown in table 3 are expressed by following formulas 1 to 4. Compound A shown in Table 3 is any one of the metal deactivators shown in Table 1.

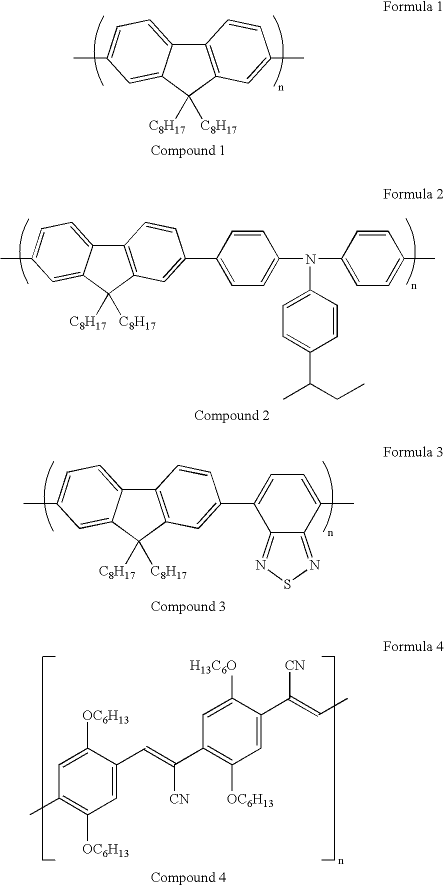

The liquid compositions 115 and 117 each contain a radical chain inhibitor (primary metal deactivator) or a peroxide decomposer (secondary metal deactivator) in addition to the metal deactivator. The radical chain inhibitor is intended to inhibit chain propagation reaction. The peroxide decomposer is intended to decompose peroxide, and, for example, contains sulfur or phosphorus.

The solubility parameter of the metal deactivator added to the liquid compositions 115 and 117 of the preferred exemplary embodiment is in the range of about 7.0 to 13.0. Since a metal deactivator with a solubility parameter in the range of 7.0 to 13.0 exhibits a high solubility and dispersibility in a solvent, it is so compatible with the organic functional material, that is, the hole injection layer material or the luminescent layer material, as to be dispersed sufficiently. Consequently, phase separation does not occur in the resulting film. Preferably the solubility parameter of the metal deactivator contained in the hole injection layer or the luminescent layer is in the range of 8.5 to 13. Preferably, the solubility of the metal deactivator in the solvent is 0.001% or more, and more preferably 5% or more. Such a metal deactivator is dissolved in the solvent, and consequently, phase separation does not occur in the resulting film.

The metal deactivator content is preferably in the range of 0.001 to 30 percent by weight, and more preferably in the range of 0.1 to 10 percent by weight, relative to the hole injection layer material or the luminescent layer material. By setting the content in these ranges, metals are successfully deactivated and the functions of the hole injection layer or the luminescent layer are not negatively affected.

Preferably, the metal deactivator is transparent or semitransparent. Such a metal deactivator reduces or prevents the hole injection layer or the luminescent layer from coloring, consequently reducing negative effects of the metal deactivator to the luminous colors of the organic EL device, for example, changes in the luminous colors and degradation of the luminance. Thus, a desired luminescent state can be achieved. A sufficiently low content of the metal deactivator in the hole injection layer or the luminescent layer does not affect the luminous color much even if the metal deactivator is colored.

Since the method to manufacture the organic EL element allows, for example, the hole injection layer and the luminescent layer, which serve as components of the organic EL element, to be formed with the film-forming apparatus (liquid discharge apparatus) IJ shown in FIG. 1, the hole injection layer and the luminescent layer are stably formed at low costs, reducing the loss of the liquid compositions used for these layers.

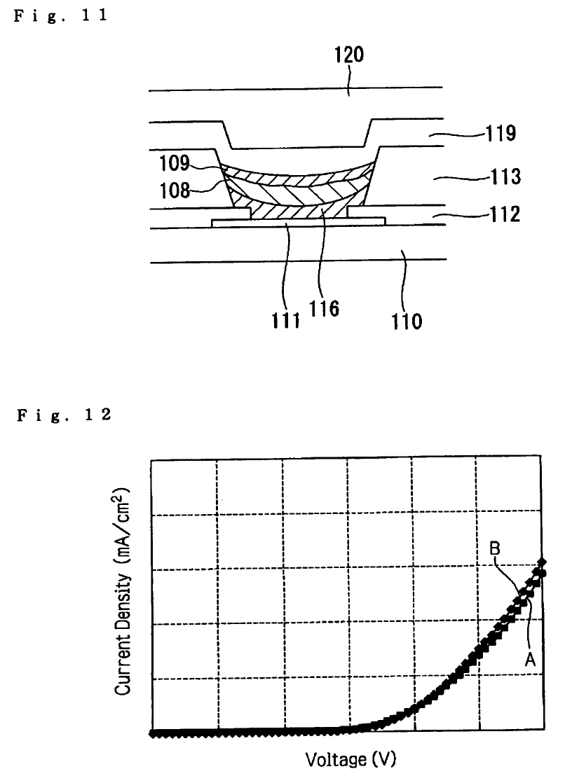

In the exemplary embodiment, the metal deactivator is added to the liquid composition in advance. Alternatively, for example, a liquid composition not containing the metal deactivator (a first composition containing the luminescent layer material) is discharged to form a first composition film 108, and then, the metal deactivator is discharged onto the first composition film 108 to form a second composition film 109 containing the metal deactivator, as shown in FIG. 11.

The second composition containing the metal deactivator may be discharged with the first composition film 108 wet, before drying (heating) the first composition film 108 containing the luminescent layer material. Thus, the luminescent layer material and the metal deactivator are mixed on the substrate P. The metal deactivator may, of course, be applied after drying the first composition film 108 containing the luminescent layer material to remove the solvent. In this instance, the metal deactivator layer 109 is provided adjoining the first composition film (luminescent layer) 108, that is, on the first composition film 108. For the application of the metal deactivator, a liquid composition containing the metal deactivator and a solvent or a liquid composition containing the metal deactivator, a solvent, and a binder may be used.

In the exemplary embodiment, the organic functional materials are deposited by liquid discharging with the liquid discharge apparatus IJ. However, film formation is not limited to that by liquid discharging, but other application methods, for example, spin coating, may be used. The second liquid composition may also be applied by spin coating.

Film formation by spin coating will be described below.

A patterned ITO 111, a SiO₂ film 112, and an organic (polyimide) film 113 are formed on a glass substrate 110 in the same manner as in FIG. 6.

After a hole injection/transport material composition B, shown in Table 4, is prepared in an normal atmosphere, hole injection/transport material composition B and any one of the metal deactivators shown in Table 1 are dissolved in an organic solvent (for example, isopropyl alcohol) in a clean room (at a room temperature of 25° C. and a humidity in the range of 35 to 45%). In the same clean room (at a room temperature of 25° C. and a humidity in the range of 35 to 45%), a hole injection/transport layer is deposited by spin coating in the area surrounded by the barrier walls of the organic (polyimide) film 113 shown in FIG. 6.

TABLE 4
Hole injection/transport material composition B

| Composition | Material | Content (wt %) |
|---|---|---|
| Hole injection/transport | Baytron P | 88.5 |
| material | Polystyrene sulfonate | 11.5 |

As for the luminescent layer, after composition G for green luminescence shown in Table 5 is prepared in an normal atmosphere as in the same manner, composition G and any one of the metal deactivators shown in Table 1 are dissolved in an organic solvent (for example, isopropyl alcohol) in a clean room (at a room temperature of 25° C. and a humidity in the range of 35 to 45%). In the same clean room (at a room temperature of 25° C. and a humidity in the range of 35 to 45%), a luminescent layer is deposited on the hole injection/transport layer formed by spin coating as above. Red luminescent composition R and blue luminescent composition B are also deposited by spin coating to form respective luminescent layers. After forming the cathode 119 (see FIG. 10), a sealing material 120 is deposited to complete an organic E1 element.

TABLE 5

| | Luminescent | | | | Compound |
|---|---|---|---|---|---|
| Composition | material (g) | | Solvent (mL) | | A (mg) |
| G (Green) | Compound 1 | 0.76 | Xylene | 100 | 1 |
| | Compound 2 | 0.20 | | | |
| | Compound 3 | 0.04 | | | |
| B (Blue) | Compound 1 | 1.00 | Xylene | 100 | 1 |
| R (Red) | Compound 4 | 1.00 | Xylene | 100 | 1 |

The preparation of the liquid composition and the deposition of the films may be performed in a normal atmosphere or an atmosphere of an inert gas, such as nitrogen. Preferably, the preparation of the liquid composition with the liquid composition-preparing unit S and the deposition of the liquid composition with the liquid discharge apparatus IJ are performed in a clean room with dust and chemical impurities eliminated. For the preparation of the liquid composition in a normal atmosphere, the organic functional material and the metal deactivator may be dissolved in a solvent at normal temperature and normal humidity (for example, at a temperature of 25° C. and a humidity in the range of 35 to 45%), or the metal deactivator may be added to a solution prepared in advance in which the organic functional material is dissolved in a solvent.

In the exemplary embodiment above, the metal deactivator is added to both the hole injection layer and the luminescent layer. However, it may be added to only one of the hole injection layer and the luminescent layer. Alternatively, it may be added to a layer other than the hole injection layer and the luminescent layer of an organic EL element including a plurality of layers.

### EXAMPLES

Examples of the liquid composition and the preparation and deposition of the liquid composition will now be described.

### Example 1

Hole injection layer liquid composition P1

Baytron P: 88.5 percent by weight

Polystyrene sulfonate: 11.5 percent by weight

Luminescent layer liquid composition E1

G (green): Compound 1 (0.76 g), Compound 2 (0.20 g), Compound 3 (0.04 g)

B (blue): Compound 1 (1.00 g)

R (red): Compound 4 (1.00 g)

To the R, G, and B luminescent materials, each were added 100 mL of xylene, as a solvent, and 1 mg of a metal deactivator shown in Table 1 (for example, 2,(2′-hydroxy-3,5′-di-t-butylpheyl)benzotriazole. Compounds 1 to 4 have been shown above.

### Example 2

Hole injection layer liquid composition P2

Baytron P: 11.08 percent by weight

Polystyrene sulfonate: 1.45 percent by weight

Isopropyl alcohol: 10 percent by weight

N-methylpyrrolidone: 27.47 percent by weight

1,3-dimethyl-imidazolinone: 50 percent by weight

Luminescent layer liquid composition E2

G (green): Compound 1 (0.76 g), Compound 2 (0.20 g), Compound 3 (0.04 g)

B (blue): Compound 1 (1.00 g)

R (red): Compound 4 (1.00 g)

To the R, G, and B luminescent materials each were added 40 mL of cyclohexylbenzene and 60 mL of 2,3-dihydrobenzofuran, as solvents, and 1 mg of a metal deactivator shown in Table 1 (for example, 2,(2′-hydroxy-3,5′-di-t-butylphenyl)benzotriazole.

Liquid composition preparation 1

### Preparation Example 1

The respective luminescent layer materials and the metal deactivator were dissolved in the solvent in a clean room in a normal atmosphere (at a room temperature of 25° C. and a humidity in the range of 35 to 45%) to prepare the liquid compositions E1 and E2.

### Preparation Example 2

The respective luminescent layer materials were dissolved in the solvent in a clean room in a normal atmosphere (at a room temperature of 25° C. and a humidity in the range of 35 to 45%) and, subsequently, the metal deactivator was added to the solutions to prepare the liquid compositions E1 and E2.

Deposition 1

### Deposition Example 1

Composition P1 was deposited by spin coating in a clean room in a normal atmosphere (at a room temperature of 25° C. and a humidity in the range of 35 to 45%). Deposited composition P1 was baked at 200° C. for 10 minutes in a normal atmosphere to form a hole injection layer. Then, composition E1 was deposited on the hole injection layer by spin coating at room temperature in a normal atmosphere.

### Deposition Example 2

Composition P2 was deposited on a substrate by liquid discharging in a clean room in a normal atmosphere (at a room temperature of 25° C. and a humidity in the range of 35 to 45%). Then, deposited composition P2 was dried to form a hole injection layer at room temperature for 20 minutes in the clean room evacuated to 1 Torr (133.322 Pa) or less. Then, the resulting film was baked at 200° C. for 10 minutes in a normal atmosphere. Then, composition E2 was deposited on the hole injection layer by liquid discharging. The film of the composition E2 was dried at 45° C. for 20 minutes in a normal atmosphere.

Liquid composition preparation 2

### Preparation Example 1

The respective Luminescent layer materials and the metal deactivator were dissolved in the solvent in a glove box in an atmosphere of nitrogen (at room temperature, a water concentration of 1 ppm or less, and an oxygen concentration of 1 ppm or less) to prepare the liquid compositions E1 and E2.

### Preparation Example 2

The respective luminescent layer materials were dissolved in the solvent in a glove box in an atmosphere of nitrogen (at room temperature, a water concentration of 1 ppm or less, and an oxygen concentration of 1 ppm or less), and subsequently, the metal deactivator was added to the solutions to prepare the liquid compositions E1 and E2.

Deposition 2

### Deposition Example 1

Composition P1 was deposited by spin coating in an atmosphere of nitrogen at a water concentration and an oxygen concentration of 1 ppm or less. Then, deposited composition P1 was baked at 200° C. for 10 minutes in an atmosphere of nitrogen to form a hole injection layer. Then, composition E1 was deposited on the hole injection layer by spin coating at room temperature in an atmosphere of nitrogen.

### Deposition Example 2

Composition P2 was deposited on a substrate by liquid discharging in an atmosphere of nitrogen at a water concentration and an oxygen concentration of 1 ppm or less. Then, deposited composition P2 was dried to form a hole injection layer at room temperature in a vacuum of 1 Torr (133.322 Pa) or less for 20 minutes. Then, the resulting film was baked at 200° C. for 10 minutes in an atmosphere of nitrogen. Then, composition E2 was deposited on the hole injection layer by liquid discharging and then dried at 45° C. for 20 minutes in an atmosphere of nitrogen.

FIGS. 12 to 15 show the results of property tests for an organic EL element whose luminescent layer contains the metal deactivator and an organic EL element whose luminescent layer contains no metal deactivator. Sign A in the graphs designates the results for the organic EL element containing the metal deactivator; sign B, those in the case of containing no metal deactivator.

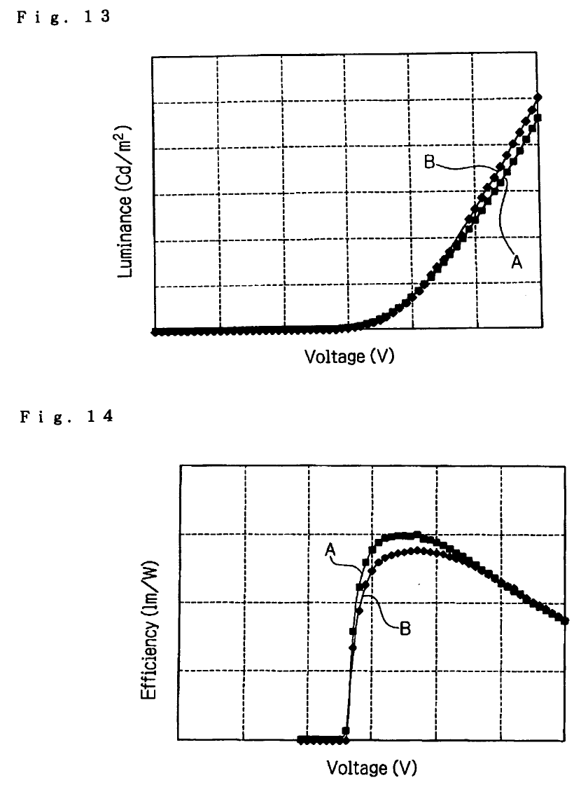

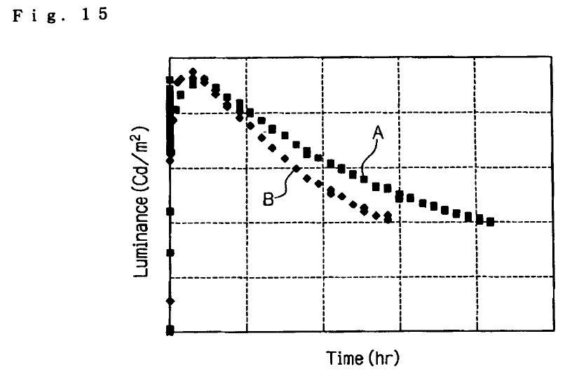

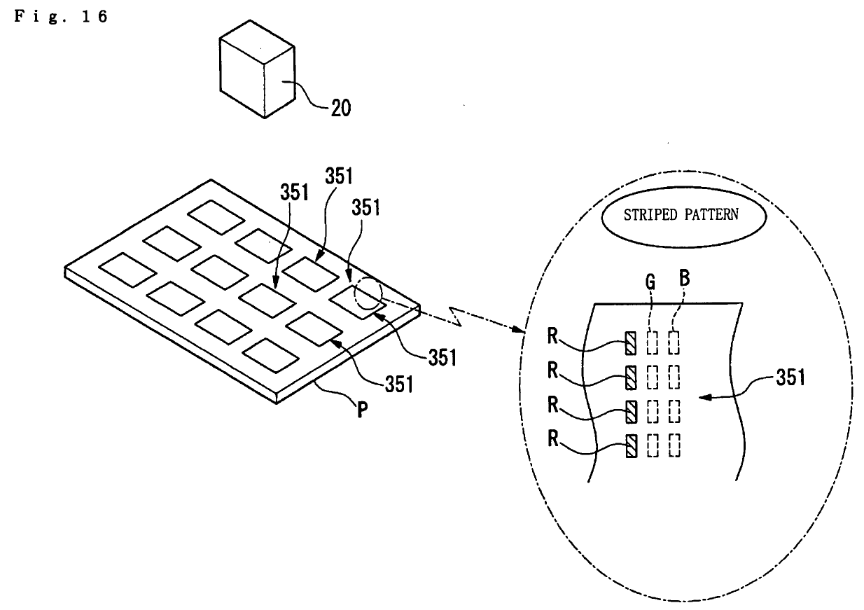

FIG. 12 shows the relationship between applied voltage and current density, and FIG. 13 shows the relationship between applied voltage and luminance. FIG. 14 shows the relationship between applied voltage and luminous efficiency, and FIG. 15 shows the relationship between operating time and luminance.

FIGS. 12 and 13 show that the properties of the organic EL elements are substantially the same whether the metal deactivator is added or not, and suggest that the capability of the organic EL element is not negatively affected by adding the metal deactivator to the luminescent layer. FIGS. 14 and 15 show that the half-lives of luminous efficiency and luminance are increased by adding the metal deactivator, and suggest that the capability of the element can be improved by adding the metal deactivator.

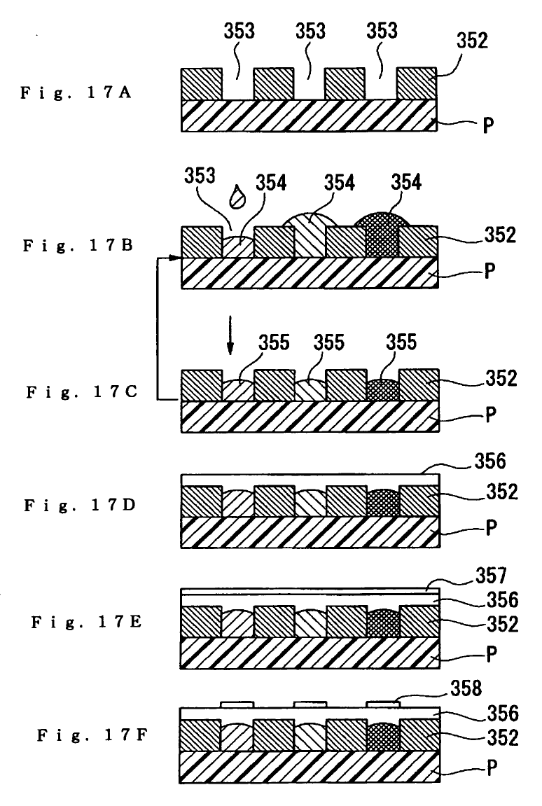

The liquid discharge apparatus IJ may be used to form films constituting a color filter. FIG. 16 shows color filters formed on a substrate P, and FIG. 17 shows steps to manufacture the color filter.

In the present exemplary embodiment, a plurality of color filter regions 351 are formed in a matrix manner on a rectangular substrate P, as shown in FIG. 16, from the viewpoint of increasing productivity. Each color filter region 351 separated by cutting can be used as a color filter in a liquid crystal display device.

For the color filter region 351, an R (red) liquid composition, a G (green) liquid composition, and a B (blue) liquid composition are deposited in a predetermined pattern, and, in the present exemplary embodiment, in a known striped pattern. The pattern may be of a mosaic, a delta, and a square, instead of the striped pattern. The metal deactivator is added to the R, G, and B liquid compositions.

For the formation of the color filter region 351, a black matrix 352 is provided on one surface of a transparent substrate P as shown in FIG. 17(a). The black matrix 352 is formed by depositing a light-shielding resin (preferably black) to a predetermined thickness (for example, about 2 μm) by spin coating or the like. A minimum segment for display surrounded by the black matrix 352, namely, a filter element 353, measures, for example, about 30 μm in width in the X-axis direction by about 100 μm in length in the Y-axis direction.

Turning to FIG. 17(b), the droplets 354 of a liquid composition are discharged from the liquid discharge head 20 to land on the filter element 353. A sufficient quantity of the droplets 354 are discharged, considering the volume reduction of the liquid composition by heating.

After all the filter elements 353 on the substrate P are filled with the droplets 354, the substrate P is heated to a predetermined temperature (for example, about 70° C.) with a heater. This heat treatment vaporizes the solvent in the liquid composition to reduce the volume of the liquid composition.

If the volume is largely reduced, deposition and heat treatment are repeated until the thickness becomes sufficient to function as a color filter. Through this process, the solvent in the liquid composition is vaporized, and, ultimately, the solid content in the liquid composition is left to form color filters 355, as shown in FIG. 17(c).

In order to planarize the substrate P and protect the color filters 355, a protective film 356 is formed on the substrate P to cover the color filters 355 and the black matrix 352, as shown in FIG. 17(d). The protective film 356 may be formed by spin coating, roll coating, or dipping, and liquid discharging may also be applied as in the formation of the color filters 355.

Turning to FIG. 17(e), a transparent conductive film 357 is formed over the entire surface of the protective film 356 by sputtering, vapor deposition, or the like. Then, the transparent conductive film 357 is patterned to form pixel electrodes 358 corresponding to the filter elements 353, as shown in FIG. 17(f). If TFTs (thin-film transistors) are used to drive the liquid crystal panel, this patterning step is omitted.

The film forming method of an aspect of the present invention can also be applied to the formation of a film serving as a component of the liquid crystal element including the substrate P having the color filters 355. Specifically, a liquid crystal device is manufactured by preparing a known liquid crystal cell from the substrate P to yield a liquid crystal element.

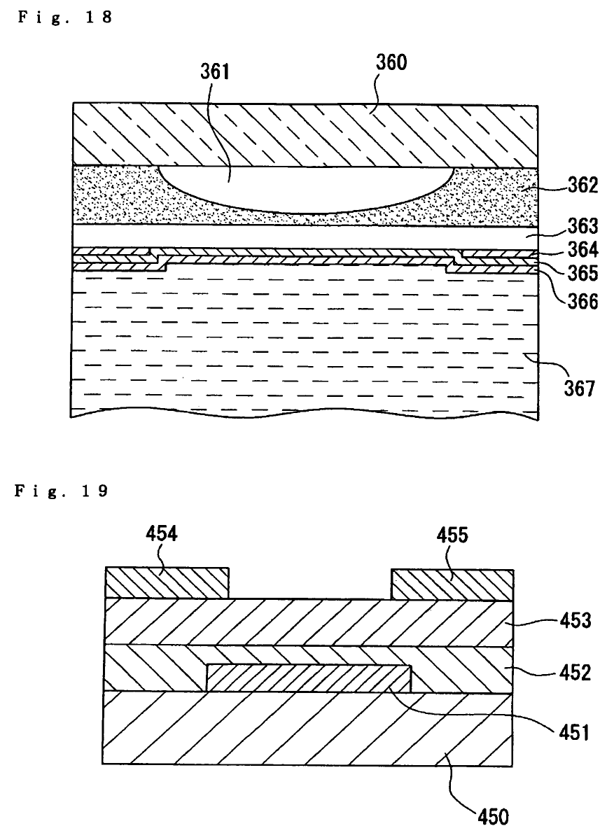

FIG. 18 shows a structural representation of a liquid crystal cell used to form the liquid crystal element. The liquid crystal device includes an opposing substrate 360 having the color filter (not shown in FIG. 18). The opposing substrate 360 is disposed opposite a circuit board (not shown in the figure) having TFTs and the like. A large number of microlenses 361 to converge light incident from the opposing substrate 360 side to the circuit board (not shown in the figure) are arranged on the inner side surface of the opposing substrate 360. On the side where microlenses 361 are provided, a cover glass 363 is bonded with an adhesive 362.

Light-shielding films 364 are formed on the inner surface side of the cover glass 363, corresponding to the boundaries between the microlenses 361. Furthermore, an opposing electrode 365 formed of a transparent conductive material, such as ITO, is provided over substantially the entire surface of the cover glass 363, covering the light-shielding films 364. An alignment layer 366 formed of an organic thin film, such as that of polyimide, is formed on the inner side surface of the opposing electrode 365. A liquid crystal 367 is sealed in the space between the opposing substrate 360 having these components and the circuit board to complete the liquid crystal device.

In manufacture of a liquid crystal device with this structure, for example, the light-shielding films 364 and the alignment layer 366 may also be formed of liquid compositions to which a metal deactivator is added in advance.

The film forming method of an aspect of the present invention can also be applied to the formation of a film serving as a component of an organic TFT element (organic thin-film transistor element) in which at least a channel portion is formed with an organic film. The organic TFT element is formed, for example, in the structure shown in FIG. 19.

In FIG. 19, a gate electrode 451 is formed on a substrate 450. The gate electrode 451 is covered with a gate insulating layer 452 formed of a dielectric insulating material on the substrate 450. On the gate insulating layer 452 is formed an organic semiconductor layer 453. The organic semiconductor layer 453 is provided with a source electrode 454 and a drain electrode 455 thereon to yield an organic TFT element (organic thin-film transistor element).

In manufacture of the organic TFT element, first, a gate electrode material is deposited on the substrate 450 to form the gate electrode 451. Then, the gate insulating layer 452 is formed to cover the gate electrode 451. The gate insulating layer 452 may be formed of various materials without particular limitation. In particular, metal oxide thin films as dielectric insulating materials are used, and preferably inorganic materials, such as barium strontium titanate and barium zirconate titanate are used. In addition, organic materials, such as polychloroprene and polyethylene terephthalate, may also be used. If the foregoing inorganic materials are used for the gate insulating layer 452, preferably, the resulting insulating layer 452 is subjected to annealing at a suitable temperature in the range of 150 to 400° C. from the viewpoint of enhancing the quality of the film and increasing the dielectric constant.

Then, the organic semiconductor layer 453 is deposited on the gate insulating layer 452. For the organic semiconductor layer 453, the liquid discharge apparatus IJ is advantageously used. The organic semiconductor layer 453 is formed of a polymer semiconductor or an oligomer semiconductor whose field-effect mobility increases as gate voltage increases, and specifically of at least one selected from the group consisting of naphthalene, anthracene, tetracene, pentacene, and hexacene and their deliveries and polyacetylene.

For a p-channel may be used oligomers of thiophenes bonded with 2 to 5 carbon atoms, having a polymerization degree in the range of 4 to 8; alternating oligomers of thienylene and vinylene having 3 to 6 thiophene rings and thiophene acting as the end group, bonded with 2 to 5 carbon atoms; linear dimer or and trimer of benzo[1,2-b:4,5′]dithiophene; oligomers whose thiophene acting as the end group has a substituent (for example, alkyl groups with a carbon number in the range of 1 to 20) on 4 or 5 carbon atoms; and p,p′-diaminobiphenyl complex in a polymer matrix. In particular, α-hexathienylene (α-6T) is preferable. In addition, for p-channel may be used 1,4,5,8-naphthalene tetracarboxylic dianhydride (NTCDA), 1,4,5,8-naphthalene tetracarboxylic diimide (NTCDI), 11,11,12,12-tetracyanonaphtho-2,6-quinodimethane (TCNNQD), and so forth.

If such an organic semiconductor material is discharged from the liquid discharge apparatus IJ to form a film, it is dissolved in a solvent in advance and a metal deactivator is added to the solution to prepare a liquid composition. The liquid composition is discharged to be applied onto the gate insulating layer 452 on the substrate 450. The applied liquid composition is appropriately dried to remove the solvent by heating or pressure reduction, thus forming the organic semiconductor layer 453. Then, the source electrode 454 and the drain electrode 455 are formed on the organic semiconductor layer 453 to yield an organic TFT element.

While the present invention has been described using the preferred exemplary embodiments above, the liquid discharge apparatus of an aspect of the present invention and the film-forming apparatus including the same and the liquid composition of an aspect of the present invention may be used in various applications without being limited to those described in the exemplary embodiments. For example, a liquid composition containing a solution of an organic paint material and a metal deactivator is applied onto an object and dried by heating to form a film, thereby reducing negative effects of a metal component on the object.

Electronic Apparatus

The electro-optic devices of an aspect of the present invention, including the organic EL device and the liquid crystal device, and the device of an aspect of the present invention with the organic TFT elements are used in various electronic apparatuses having a display. Application of the electro-optic device of an aspect of the present invention to an electronic apparatus will be described below.

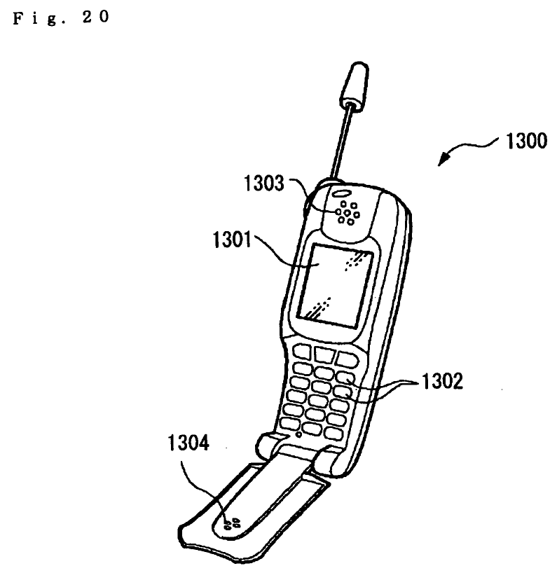

FIG. 20 is a perspective view of a cellular phone using the electro-optic device of an aspect of the present invention. The cellular phone 1300 includes the electro-optic device as a small display 1301. The cellular phone 1300 also includes a plurality of operation buttons 1302, an earpiece 1303, and a mouthpiece 1304.

In addition to the cellular phone, exemplary electronic apparatuses of an aspect of the present invention include, for example, wristwatches, mobile computers, liquid crystal TV sets, viewfinder-type and monitor-direct-view-type video tape recorders, car navigation systems, pagers, electronic notebooks, electronic calculators, word processors, work stations, video phones, POS terminals, and apparatuses having touch panels. The electro-optic device of an aspect of the present invention can be used as the displays of these electronic apparatuses.

What is claimed is:

1. A method of manufacturing an organic electroluminescent device having a plurality of material layers, comprising:
adding a metal deactivator to a solution containing a material of at least one of the material layers and a solvent to prepare a liquid composition; and
depositing the material layer of the liquid composition on a base material, the solubility parameter of the metal deactivator being in the range of 7.0 to 13.0, and the metal deactivator being in the range of 0.1 to 10 percent by weight relative to the functional element.

2. A method of manufacturing an electro-optical device according to claim 1, the material layer being formed by discharging a liquid containing the liquid composition from a liquid discharge apparatus.

3. A method of manufacturing an electro-optical device according to claim 1, depositing the material layer is performed by ink-jet process.

4. A method of manufacturing an electro-optical device according to claim 1, wherein the material layer is an electroluminescent layer.

5. A method of manufacturing an electro-optical device according to claim 1, wherein the material layer is a hole injection layer.
